(19) United States
(12) Patent Application Publication
(10) Pub. No.: US 2013/0073470 A1
(43) Pub. Date: Mar. 21, 2013

(54) METHOD AND SYSTEM FOR PROVIDING ONLINE TROUBLE TICKET SERVICING

(71) Applicants: Chris L. White, Plano, TX (US); Evan Pedersen, Colorado Springs, CO (US); Rebecca S. Little, Colorado Springs, CO (US); Xiao-Qing Li, Colorado Springs, CO (US); Robert Scherer, Cary, NC (US)

(72) Inventors: Chris L. White, Plano, TX (US); Evan Pedersen, Colorado Springs, CO (US); Rebecca S. Little, Colorado Springs, CO (US); Xiao-Qing Li, Colorado Springs, CO (US); Robert Scherer, Cary, NC (US)

(73) Assignee: VERIZON PATENT AND LICENSING INC., Basking Ridge, NJ (US)

(21) Appl. No.: 13/236,860

(22) Filed: Sep. 20, 2011

(51) Int. Cl. G06Q 10/00

(52) U.S. Cl. 705/304

(57) ABSTRACT

An approach is provided for online trouble ticket servicing. Communication is initiated with a user for creation of a trouble ticket by an online trouble ticket service. A determination is made whether the user is associated with an online account of the trouble ticket service. Based on the determination, a graphical user interface is presented and includes a feedback area to specify information indicating a reason for non-usage of the online account for the trouble ticket service.

### BACKGROUND INFORMATION

Modern communication systems involve a delicate interplay of network components and associated facilities to reliably provide a host of services (e.g., voice and data services, content delivery, etc.) for a service provider. These systems are vital to business operations, whereby any downtime can impose a significant cost to the service provider. The impact of network failures (even very minor ones lasting only minutes) can be measured in thousands or even millions of dollars. Therefore, customers are acutely aware of problems that arise with such systems and have a vested interest in ensuring that these problems are resolved in a timely manner. Consequently, “trouble ticket” systems have been developed to track problem events that arise in the system, along with the activities being taken to resolve such problems. For example, to obtain the current status of a trouble ticket, a customer may contact a customer service representative or agent of the service provider, as to have the representative access and relay the status of the trouble ticket. Furthermore, due to the impact that such problem events can have on the operation of the customer's business, the customer may repeatedly and frequently contact the customer service center, which can place a heavy burden on the resources of the customer service center. Further, this situation can be frustrating to customers that do not have any other means of determining whether the problem is in the process of being resolved, and may feel as though the problem is being overlooked by the service provider. However, because a trouble ticketing system is traditionally an internal operations system, access to this such system by the end user or customer is gravely limited to protect against security compromises and/or unnecessarily exposing the internal workings of or information about the service provider. Hence, traditional trouble ticketing systems support little to no interaction directly with the customer.

Based on the foregoing, there is a need for a trouble ticket system that can provide customers some interaction with the system.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system configured to provide online trouble ticket management, according to one embodiment;

FIG. 2 is a flowchart of a process for utilizing an online trouble ticket management system, according to one embodiment;

FIG. 3 is a flowchart of a process for obtaining feedback information for encouraging use of an online trouble ticket management system, according to one embodiment;

FIG. 4 is a diagram of the trouble ticket management system and the communication platform utilized in the system of FIG. 1, according to various embodiments;

FIGS. 5A-5G are diagrams illustrating exemplary elements of a graphical user interface for managing trouble tickets, according to various embodiments;

FIG. 6 is a diagram of a graphical user interface for providing notification of a successful trouble ticket, according to one embodiment;

FIG. 7 is a diagram of a graphical user interface providing a prompt for logging on an online trouble ticket service, according to one embodiment;

FIG. 8 is a diagram of a graphical user interface establishing a user account for an online trouble ticket service, according to one embodiment;

FIG. 9 is a diagram of a computer system that can be used to implement various exemplary embodiments; and

FIG. 10 is a diagram of a chip set that can be used to implement various exemplary embodiments.

### DESCRIPTION OF THE PREFERRED EMBODIMENT

A preferred apparatus, method, and software for online trouble ticket servicing are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a trouble ticketing service, it is contemplated that various exemplary embodiments are also applicable to other services, particularly online transactional services.

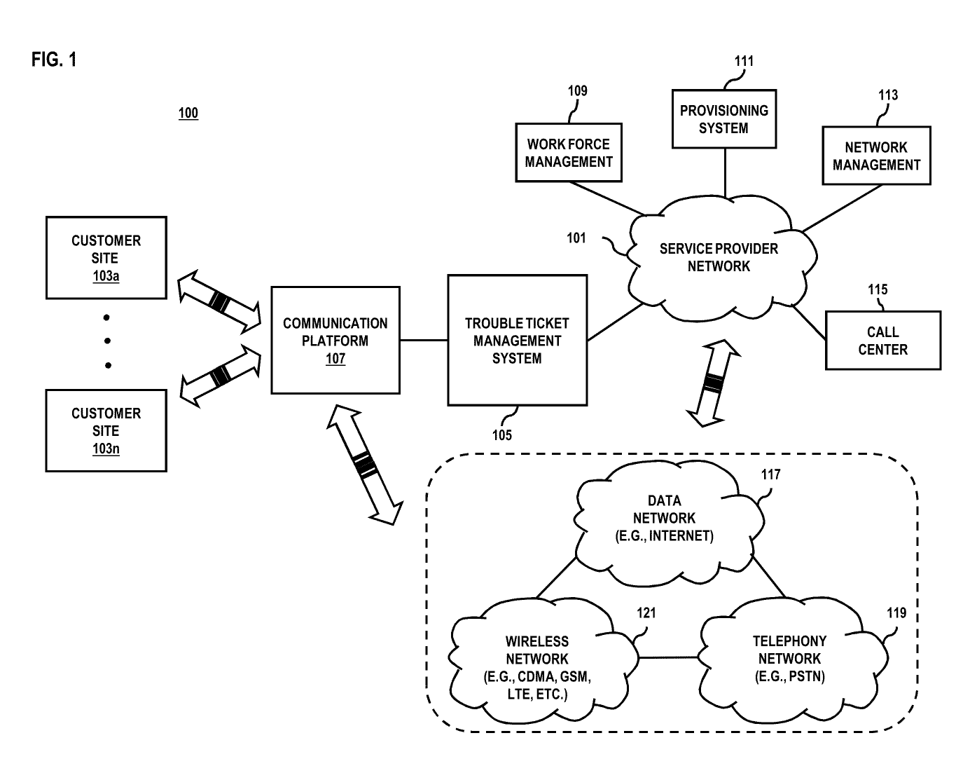

FIG. 1 is a diagram of a system configured to provide online trouble ticket management, according to one embodiment. For purpose of illustration, a service provider network 101 is configured to provide communication services (e.g., voice, data, video, etc.) to various end users (e.g., customers or subscribers) at customer sites 103a-103n. Although not shown, each of the customer sites 103a-103n can include various equipment and/or communication infrastructure to receive the communication services. That is, the various communication conduits or facilities used to provide the services to the customers can include the use of any form of wired or wireless communication architecture (e.g., land-line, cable, fiber optic, satellite-based, cellular, or other communication architecture). Moreover, the customer can be an individual, or any an entity, such as a corporation, enterprise, or organization, that receives services from the service provider network 101. As part of its operations, the service provider can deploy a trouble ticket management system 105 to address problems associated with the services. Among other functions, trouble ticket management system 105 provides creation of an order or “trouble ticket” to resolve a particular service issue.

As mentioned, traditionally, trouble ticket systems are support subsystems that are not accessible by the end users or customers, but are internally utilized and managed by the service provider. Even though users have become acclimated to conducting online transactions, ranging from purchases of goods and services to self-management of these services, users can be easily deterred if the process is complex or cumbersome.

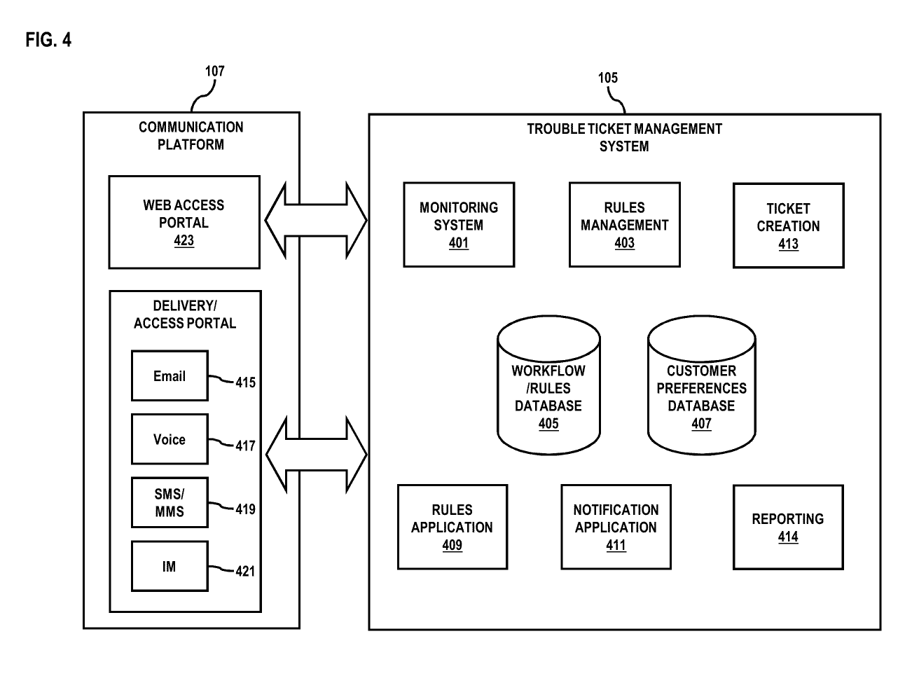

As shown, a communication platform 107 permits trouble ticket management system 105 to be accessed by customer sites 103a-103n using various technologies. For example, a customer may communicate a problem or issue using a web portal, email, a messaging service (e.g., Short Messaging Service (SMS), Multimedia Messaging Service (MMS), instant messaging (IM), etc.), voice communication, pager, etc. The communication platform 107 is further detailed in FIG. 4.

According to certain embodiments, the service provider network 101 includes a workforce management system 109, a provisioning system 111, and a network management system 113. The workforce management 109 monitors and controls allocation of human resources (e.g., technicians) to perform various tasks needed to provide customers with the services, such as set-up and maintenance of customer's services. The provisioning system 111 provides acquisition of resources to implement the particular services to the customers. The network management system 113 ensures high network availability and performance by monitoring equipment and facilities of service provider network 101 and initiating network restoration procedures, for example.

To process customer problems and concerns that arise with the customer's services, the service provider network 101 can utilize a call center 115 to handle customer requests received via communication platform 107. As noted, the trouble ticket management system 105 allows for the creation of a trouble ticket for a customer problem, which can be used to track the activities or steps being taken to resolve the problem. In order to determine the status of the actions being taken with regard to a problem, the customer can contact a customer service representative at the call center 115, and the customer service representative can access the trouble ticket management system to determine the status of the trouble ticket. System 105 can also provide automated updating and reporting of trouble ticket status to customers via a communication platform 107.

Under the example of FIG. 1, service provider network 101 may interface with one or more communication networks: data network 117, telephony network 119, and wireless network 121. Networks 117-121 may be any suitable wireline and/or wireless network. For example, telephony network 119 may include a circuit-switched network, such as the public switched telephone network (PSTN), an integrated services digital network (ISDN), a private branch exchange (PBX), or other like network. Also, wireless network 121 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Moreover, data network 117 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

In terms of customer satisfaction, it is beneficial for the service provider network 101 to provide customers with the most up-to-date status of the trouble ticket as possible. Additionally, in terms of efficient utilization of resources, it is also beneficial for the service provider network 101 to provide customers with automated access to the status of the trouble ticket. For example, due to the fact that service-downtime can have dramatic effects on a customer entity's ability to conduct business, a corporate customer may repeatedly contact a call center 115 to determine the status of the trouble ticket, in a system that does not include an automated trouble ticket status update system. Such a situation can result in an extremely heavy volume of calls to a call center, which requires that the service provider network employ and provide the needed resources to a large number of call center employees in order to process such calls.

The trouble ticket management system 117 and communication platform 107 allow a customer to obtain the status on a trouble ticket without the need to contact an agent in an inbound call center. The trouble ticket management system 117 can automatically monitor the repair progress of trouble tickets and determine the current status summary by noting, e.g., date and time the ticket is created, analysis of test results, reason why a ticket is on hold and pending dispatch, overall time to repair, when the last update was made to the ticket, etc. The customer can access such status summary information whenever desired, and/or can be automatically apprised (i.e., without a request by the customer) of such status summary either on a periodic basis or on an event-triggered basis, as desired by the customer.

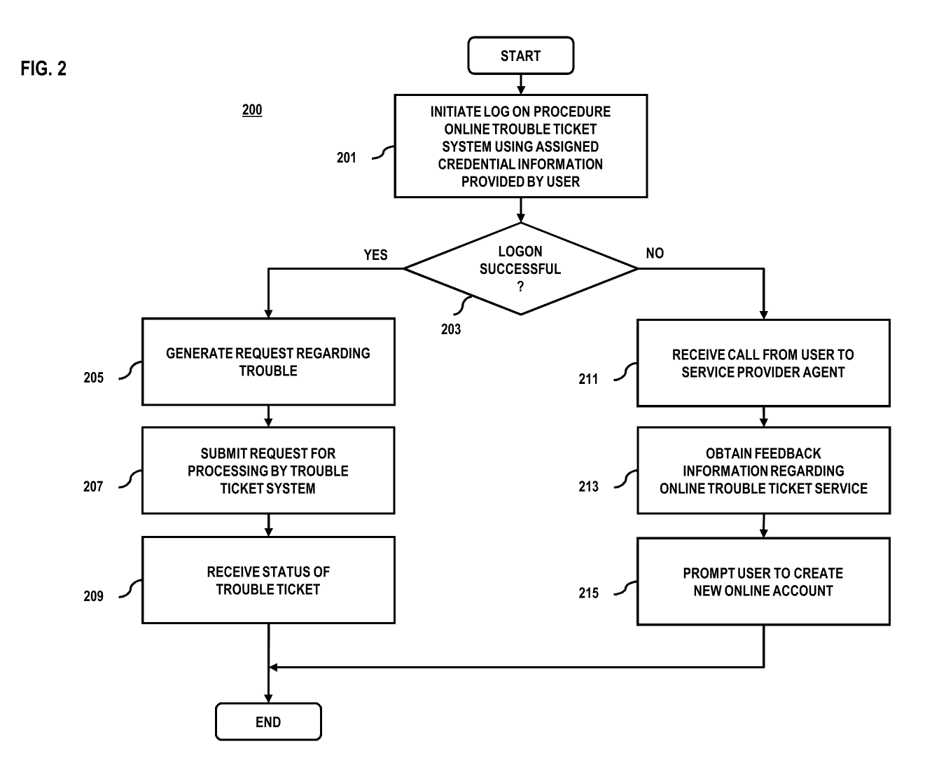

However, customers may, for one reason or another, not take advantage of online capabilities of trouble ticket management system 105, as illustrated in FIG. 2.

FIG. 2 is a flowchart of a process for utilizing an online trouble ticket management system, according to one embodiment. Process 200 provides, per step 201, the initiation of a logon procedure to trouble ticket management system 105. Such communication session can, for example, be established using a browser application by a customer with the communication platform 107, which then interfaces trouble ticket management system 105. Process 200 then determines whether the logon procedure is successful, as in step 203. In one embodiment, any known logon procedure involving the authentication of the user can be utilized. For example, the user can be prompted to supply various credential information, such as, a user identifier (ID) and a passcode. If the logon procedure is successful, the user (e.g., customer) can access trouble ticket management system 105 to generate a request regarding a particular trouble or problem with a service, as is step 205. In step 207, the request is submitted for processing by the trouble ticket management system 105. Subsequently, the trouble ticket management system 105 can supply status information about the particular trouble to the customer (step 209).

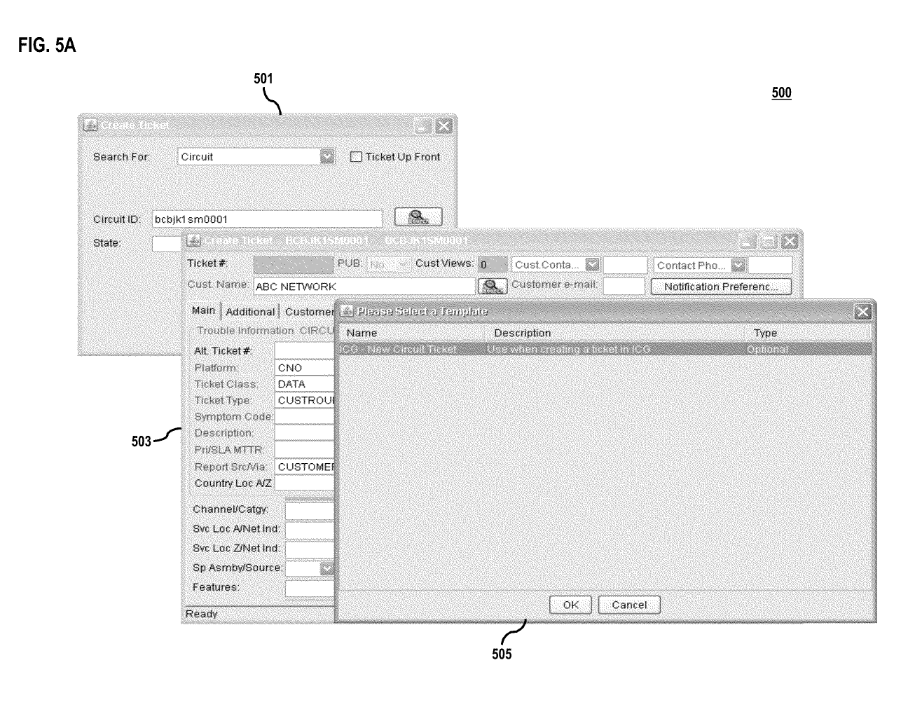

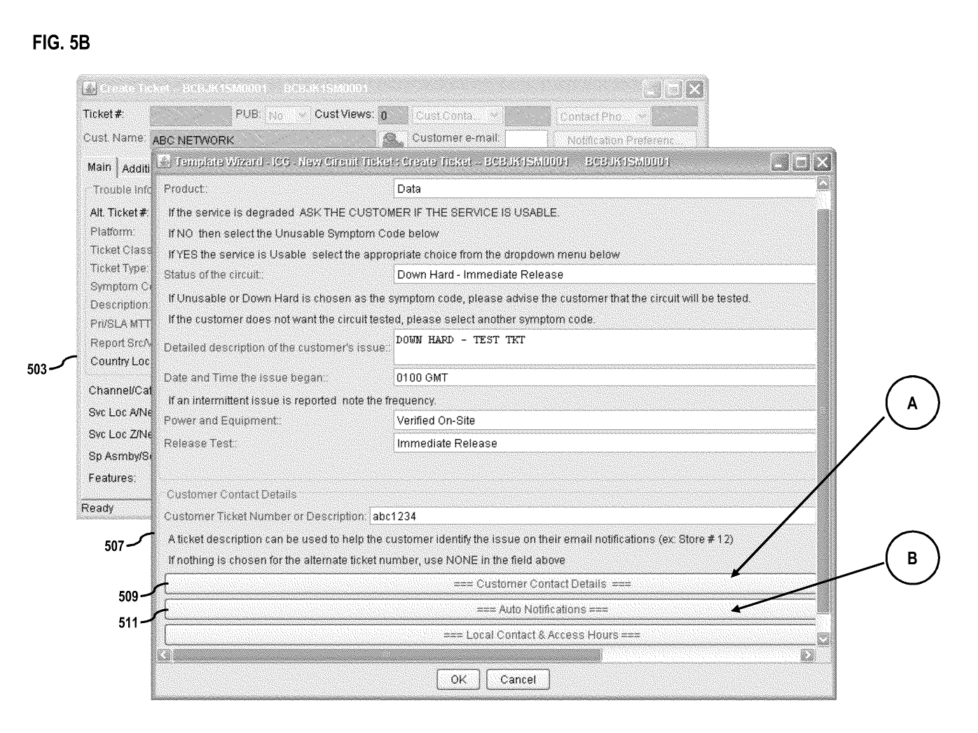

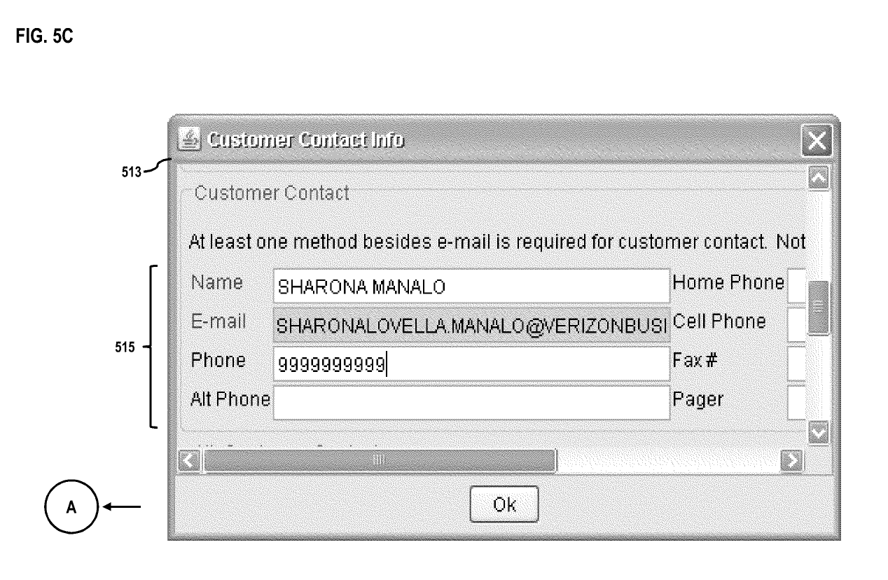

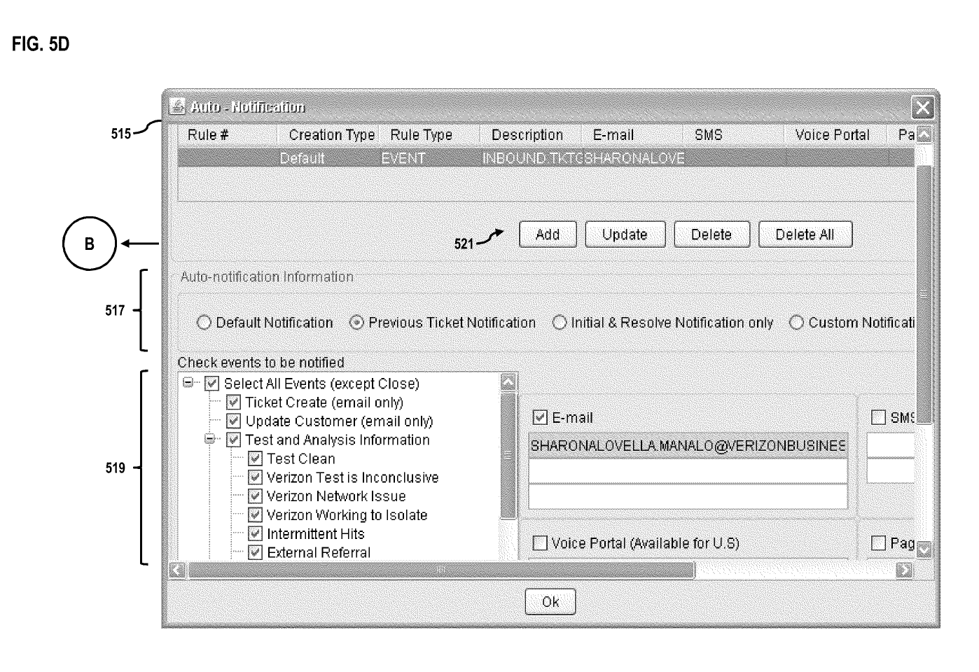

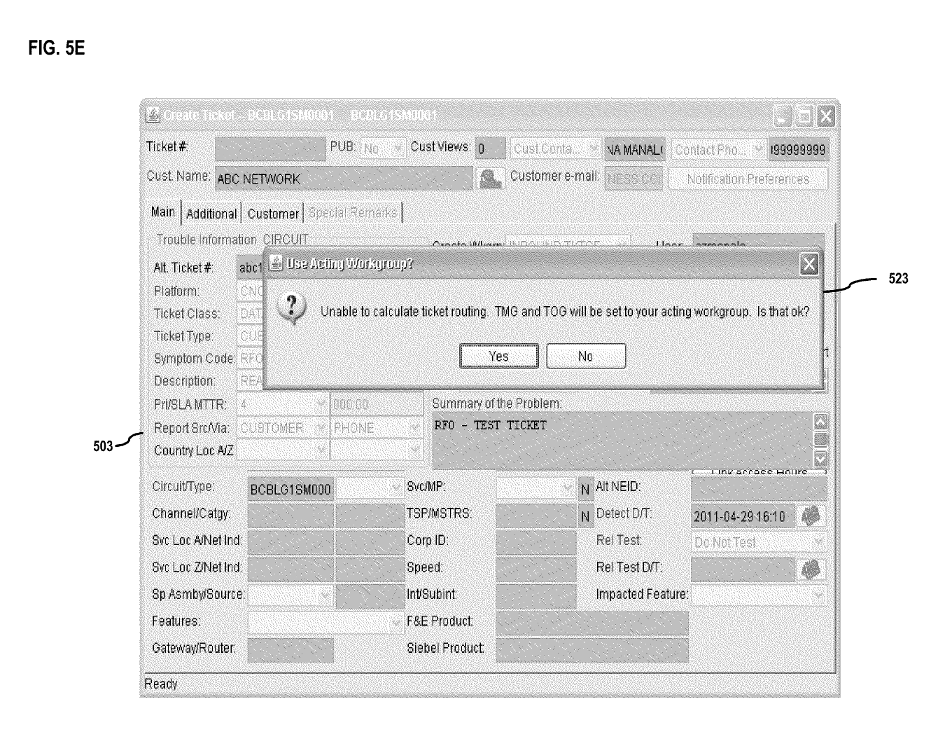

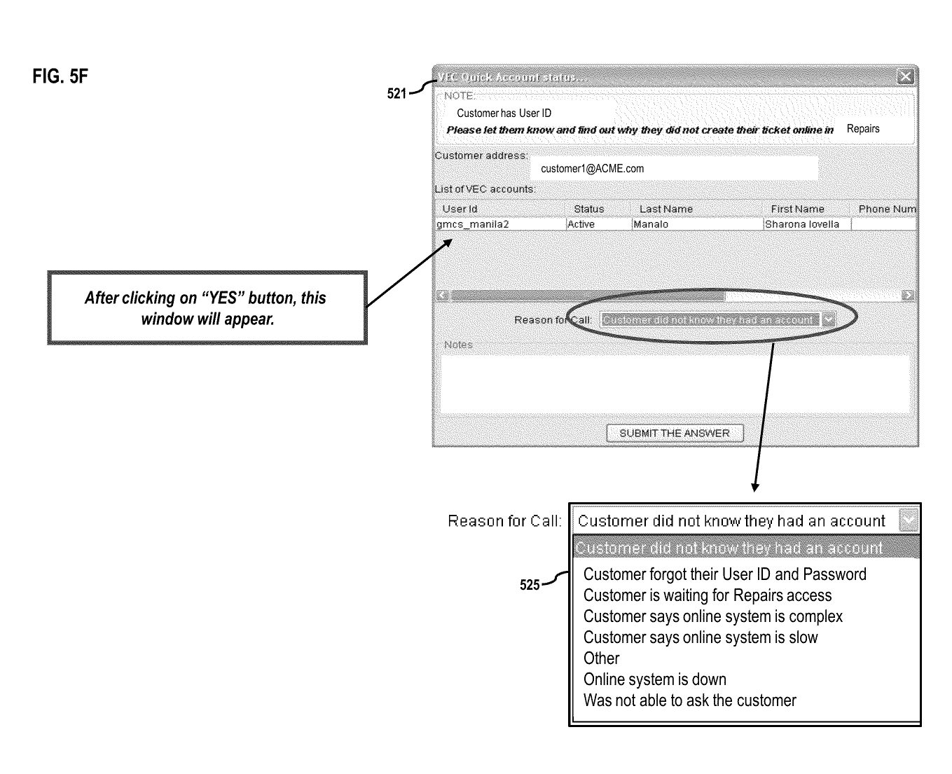

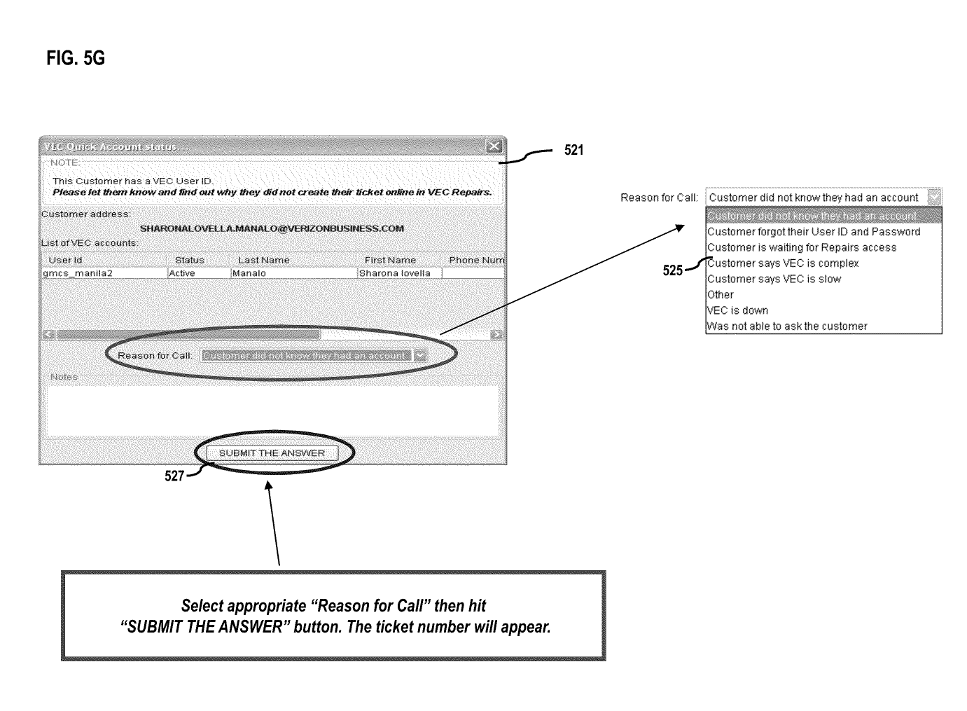

However, if the logon procedure is unsuccessful for any reason, e.g., the customer has forgotten the necessary credential information, the customer generally would resort to “off-line” means. For instance, the customer may place a call into call center 115 to speak with a service provider agent (step 211), who can assist with the creation of a trouble ticket. In effect, the agent would be the one to interface with the trouble ticket management system 105 to create the trouble ticket, as opposed to the customer. This outcome can undermine the online capability of the trouble ticket management system 105 with respect to how the end users (or customers) themselves can generate the trouble tickets. The objective of the service provider with such capability is to reduce resources and improve customer service; when the customers are deterred from using this capability such objective is gravely undercut. In recognition of this issue, trouble ticket management system 105 provides a capability to obtain feedback from customers on why they are not using the online system. Accordingly, in step 213, trouble ticket management system 105 can obtain feedback information through, in certain embodiments, a graphical user interface (GUI)—e.g., FIGS. 5F and 5G. In one scenario, the customer may not be enrolled or have registered for the online access; such a scenario is plausible, if the customer is an organization and a new administrator for that organization is attempting to submit a trouble ticket request. Nonetheless, the customer may be prompted to create a new online account, as in step 215.

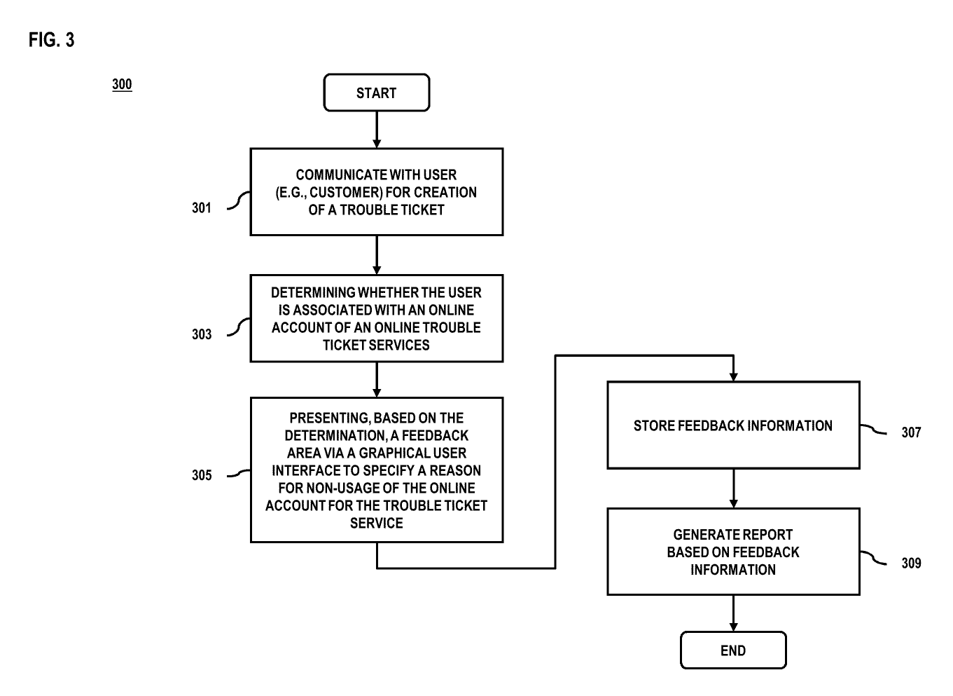

The process, in some embodiments, for obtaining feedback can proceed in the manner described with respect to FIG. 3.

FIG. 3 is a flowchart of a process for obtaining feedback information for encouraging use of an online trouble ticket management system, according to one embodiment. Process 300 involves, per step 301, communication being initiated with a user for creation of a trouble ticket by an online trouble ticket service. In step 303, a determination is made whether the user is associated with an online account of the trouble ticket service. Based on the determination, a graphical user interface (GUI) is presented and includes a feedback area to specify information indicating a reason for non-usage of the online account for the trouble ticket service (step 305). By way of example, the GUI can include the elements shown in FIGS. 5F and 5G. The feedback information is then stored for later analysis, as in step 307. In step 309, one or more reports can be generated based on the feedback information for analysis. According to certain embodiments, the feedback information obtained from the particular customer can be compiled with feedback data from other customers to assist with the analysis. For example, if the majority of the customers indicate the same reasons for why they are not using the online trouble ticket management system 105 to process a problem, then the service provider can readily determine an appropriate approach to encourage such usage. By way of example, if customers in general convey that the system 105 is complex or slow, then an engineering solution can be developed to reduce the complexity and improve the user-friendlessness of the system as well as enhance the speed of processing. If the majority of the customers reveal that they did not even realize they had user accounts, the service provider can commit more resources to informing these customers, for instance.

FIG. 4 is a diagram of the trouble ticket management system and the communication platform utilized in the system of FIG. 1, according to various embodiments. By way of example, the trouble ticket management system 105 includes a monitoring system 401, a rules management module 403, a workflow/rules database 405, a customer preferences database 407, a rules application module 409, a notification application module 411, a ticket creation module 413, and a reporting module 414. The monitoring system 401 is used to monitor events that occur in the trouble ticket management system 105 for analysis. The rules management module 403 allows a manager to create, define, modify, and delete rules and workflows that determine when an event in the trouble ticket management system 105 triggers a status summary update and/or communication with the customer.

The workflow/rules database 405 stores the various workflows and rules. Engineers, for example, can identify exactly what has to happen to trigger the new event (e.g., events can only be triggered by certain workgroups, types of users, or a person), and/or there can be exceptions built into the system, for example, conditional logic can bet applied to the new trigger.

The customer preferences database 407 stores the customer's preference regarding the manner in which they receive or access status summary updates, for example, the portal via which the prefer to receive or access such updates (e.g., via email, voice, short message service (SMS), multimedia message service (MMS), instant messaging (IM), web, etc.), their contact information, the frequency of updates (e.g., on a periodic basis at a certain interval, on an event basis, etc.).

The rules application module 409 receives the event updates detected by the monitoring system 401 and applies the triggering criteria from the workflow/rules database 405 to determine if a status summary update has been triggered. The notification application module 411 receives the triggered status summary updates determined by the rules application module 409 and applies the customer preferences from the customer preferences database 407 to determine if and in what manner a status summary update should be communicated to or made available to the customer via the communication platform 107.

Ticket creation module 413 enables a user to establish a trouble ticket for the services offered by the service provider. By way of example, the service provider is a provider of telecommunication services, whereby customers can provision, e.g., circuits for their networks. The ticket creation process can be assisted by the graphical user interface shown in FIGS. 5A-5G, according to one embodiment. The user can be a customer or an agent (associated with call center 115). However, as mentioned, trouble ticket management system 105 can encourage the customers to create the trouble tickets themselves, rather than require resources of the service provider to be expended. The resulting cost savings (stemming from the more efficient use of resources) can be returned to the customers in form of reduce circuit costs, etc. Further, the customers can more timely learn of the measures taken to resolve their service problems. After creation of the trouble ticket by module 413, the ticket can be supplied to the work force management system 109 for dispatch of a technician, for instance.

In one embodiment, the ticket creation module 413 has the capability to acquire feedback information from one or more customers regarding why they are not utilizing the online service provided by system 105 to create trouble tickets on their own. The feedback information can be used to generate various reports via reporting module 414 to assist with developing a method to encourage usage of the online service.

As seen, the communication platform 107, in one embodiment, includes a communication (or delivery/access) portal having an email portal 415, a voice portal 417, an SMS/MMS portal 419, and an instant messaging (IM) portal 421. The communication platform 107 also includes a web access portal 423. The communication portal 413 allows trouble ticket management system 105 to automatically send status summary updates to the customer, and/or allows the customer to proactively access and retrieve such status summary updates via the various portals 415-421 as, e.g., specified by the customer. For example, upon updating of the status summary, the notification application 411 could direct a telephone communication to the customer contact number that provides an automated voice message indicating the updated status summary, and could provide the customer with a series of interactive menus that allow the customer to take further actions with regard to the trouble ticket or to obtain further information about the status summary, etc. Similarly, such updates could be available to the customer via email, SMS/MMS text, instant messaging, or web access portal, based on the customer's preferences.

The communication platform 107 can provide automated status summary messages to be sent to the customer upon initiation of the trouble ticket management system 105, or for the customer to contact the trouble ticket management system 105 to retrieve messages. Such messages can be presented to the customer as either a one way communication, or can provide the customer with the ability to communicate further information to the system 117 and/or request and retrieve additional information (e.g., using web links, or telephone menus, contact email addresses, etc.).

FIGS. 5A-5G are diagrams illustrating exemplary elements of a graphical user interface for managing trouble tickets, according to various embodiments. For the purpose of illustration, the service involved with trouble ticket creation and management is that of procurement of network resources, e.g., circuits and associated equipment. In FIG. 5A, GUI 500 includes a window 501 for specifying what type of network resource; in this example, the network resource is a circuit, whereby a circuit ID text box is provided to specify the particular circuit. Window 503 can accommodate the entry of various information about the subject trouble; the particular details of such information are dependent on the particular service. Additionally, window 505 can be presented to list one or more templates that are used to create a trouble ticket.

As shown in FIG. 5B, a template wizard can be presented to assist the user (e.g., agent of the call center 115) in specifying the details about a service, which in this case is a data service.

At this point in the trouble ticket creation process, the agent is in communication with the customer to obtain information about the problem the customer is having related to a data service. Window 507 provides, in this example, text boxes for data entry for the following information: Product, Status of Circuit, Detailed Description of the Customer's Issue, Data and Time the Issue Began, Power and Equipment, and Release Test, and Customer Ticket Number or Description.

Within window 507, various prompts are provided to the user to guide the customer, such as: “ASK THE CUSTOMER IF THE SERVICE IS USABLE” pertaining to the Product field. Based on the response, the user is prompted to supply different information: “If NO then select the Unusable Symptom Code below” or “If YES the service is Usable select the appropriate choice from the dropdown menu below.” Other fields, such as Status of the Circuit can similarly guide the user to populating the template wizard with information. For example, with respect to the Status of the Circuit, the user may designate that the state or status of the circuit is “Down hard—Immediate Release,” in which case the window 507 provides the user with instructions to advise the customer that the circuit will be tested. However, if the customer does not elect to have the circuit tested, then window 507 can indicate that another symptom code needs to be specified.

Further, a Customer Contact Detail button 509 can be presented within window 507, such that activation or selection of this button 509 will launch another window 513 (shown in FIG. 5C). As seen, a customer contact information window 513 can present certain fields to permit the user to input the customer contact details within section 515, such as name, email, primary phone number, alternate phone number, home phone number, cellular phone number, fax number, pager number, etc.

Returning to FIG. 5B, an auto notifications button 511 can be selected to invoke window 515 of FIG. 5D. This auto notifications window 515 enables the user to specify how the customer is to be notified of the status or resolution of the trouble ticket. For example, section 517 can enumerate the options available for such automatic notification—e.g., default notification, previous ticket notification, initial and resolve notification only, and/or custom notification. By selecting one or more of these options 517, the customer is alerted accordingly via various specified methods: email, SMS, voice portal, pager, etc. The default notification setting can be configured when the account is established. Also, the user can select the method of notification based on a method used in a previous ticket. The option of “initial and resolve notification only” provides a minimal amount of alerts, whereby a notification message is supplied at the initial request stage and another message upon resolution of the problem. Further, the user can select, using section 519, the particular events to be notified of—e.g., when the ticket is created, activities involved with testing of the circuit, etc.

FIG. 5E shows an example of a window 523 that provides an indicator relating to determining the trouble ticket route, and configuring a workgroup. For example, the agent of call center 115 can be assigned to a particular workgroup from various workgroups, which can be organized according to the service. In such a scenario, window 523 notifies the user (e.g., agent) that the system 105 is unable to calculate the ticket routing.

As shown in FIG. 5F, according to certain embodiments, window 521 can permit the user (e.g., agent) to easily specify the reason for the call (rather than the customer creating the trouble ticket own his/her own using the online trouble ticket management system 105). To facilitate the data entry process, a drop-down menu 525, as a feedback area within window 521, can be utilized to list the common reasons customers state, per Table 1:

TABLE 1

| No. | Reason |
|---|---|
| 1 | Customer did not know they had an account |
| 2 | Customer forgot their User ID and Password |
| 3 | Customer is waiting for Repairs access |
| 4 | Customer says online system is complex |
| 5 | Customer says online system is slow |
| 6 | Other |
| 7 | Online system is down |
| 8 | Was not able to ask the customer |

It is contemplated that the feedback area 525 can be provided in a different form other than a drop down menu, such as a series of buttons corresponding to the reasons listed in Table 1. Upon selecting the reason, the user/agent is then prompted by an answer button 527 to submit the selection. Such a prompt can avoid inadvertent input of data, thereby minimizing data entry errors.

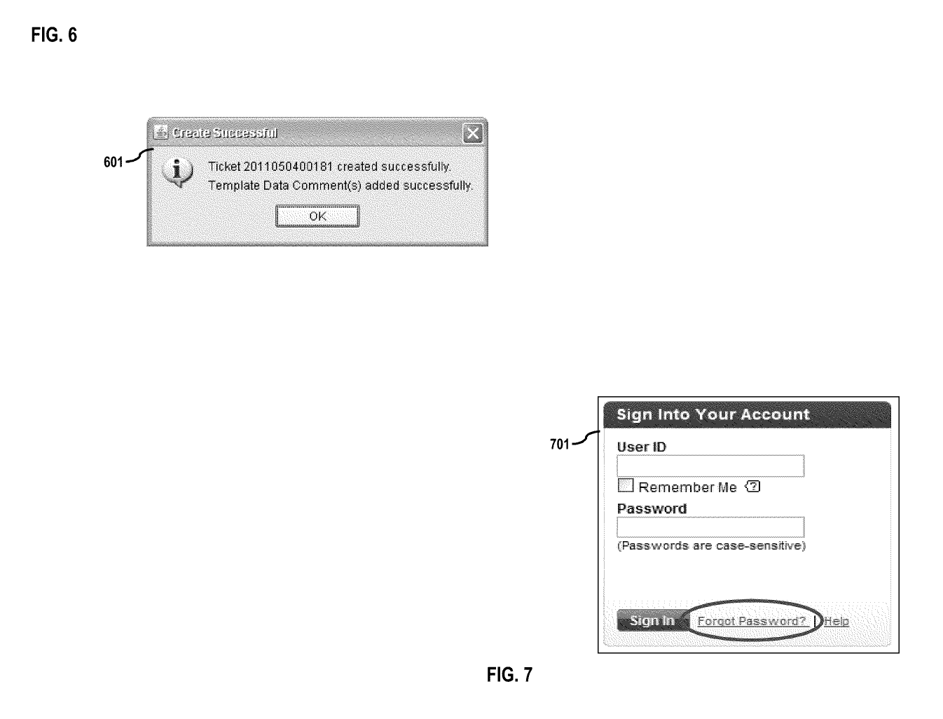

The described windows (e.g., screenshots) can follow a process sequence pertaining to when the customer calls the call center 115 to resolve an issue about the service. In this example, screenshot 500 can be the initial screen for the start of the trouble ticket creation, and the screenshot of FIG. 5E can be next in the sequence, followed by the GUI of FIGS. 5F and 5G. The successful completion of the trouble ticket creation can indicated to the user with a pop-up box (or window 601), as shown in FIG. 6.

FIG. 7 is a diagram of a graphical user interface providing a prompt for logging on an online trouble ticket service, according to one embodiment. By way of example, window 701 captures the credential information from the user (agent); in some embodiments, the credential information can include a User ID and a Password (or passcode). It is noted that window 701 also provides hyperlinks in the event the user has forgotten the credential information (e.g., password): “Forgot Password” and “Help.” For instance, activation of the Forgot Password link can direct to user on how to obtain the password; e.g., a new password can be sent to the user's email. The Help link can instruct the user on how to reset the password or diagnose the problem with the logon process.

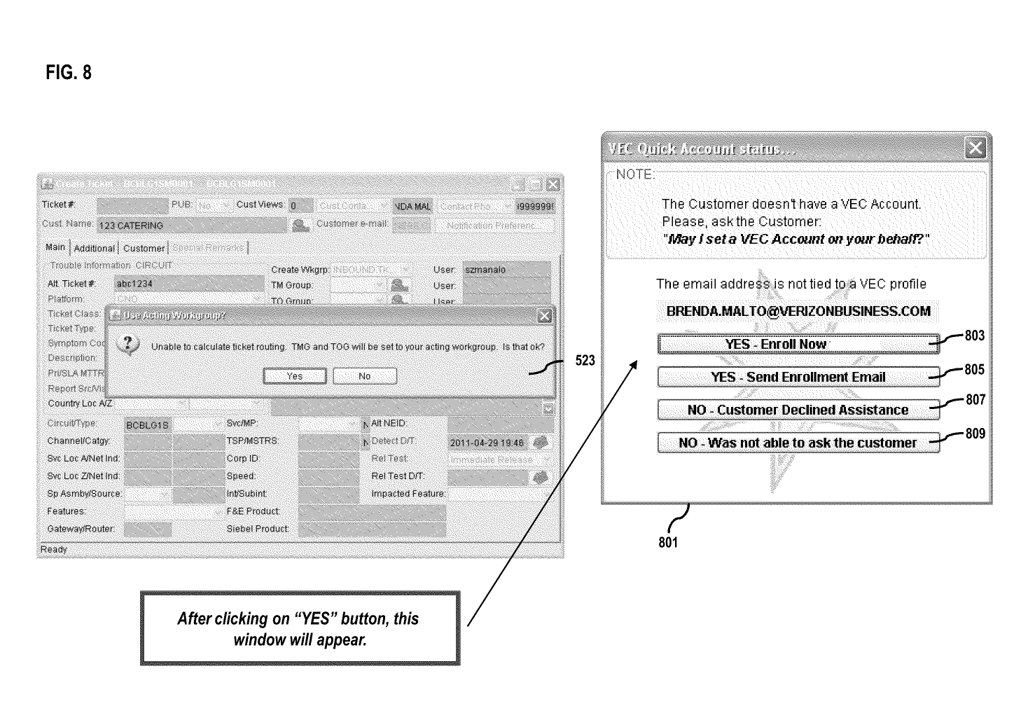

FIG. 8 is a diagram of a graphical user interface establishing a user account for an online trouble ticket service, according to one embodiment. The scenario depicted in FIG. 8 relates to the manner in which the user responds to the prompt provided in window 523 of FIG. 5E. Under this scenario, the customer does not have a user account for the service, and thus the user (e.g., agent of call center 115) is prompted to ask the customer whether the customer wishes to establish a user account with system 105. In one embodiment, a customer identifier, such as the customer's email, can be correlated with a customer profile. By way of example, window 801 provides a convenient interface for the user to select the following options (per Table 2):

TABLE 2

| Button | Description |
|---|---|
| 803 | Yes - Enroll Now |
| 805 | Yes - Send Enrollment Email |
| 807 | No - Customer Declined Assistance |
| 809 | No - Was not able to ask the customer |

In some embodiments, the customer can accept the request to enroll either immediately during the call with the agent (by selecting button 803), or alternatively, will receive instructions on how to do so via email (by selecting button 805). However, the customer may decline to the invitation to enroll, in which the agent would select 807. If the user were not able to ask the customer in the first place to enroll, then button 809 is selected.

The processes described herein for providing online trouble ticking servicing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

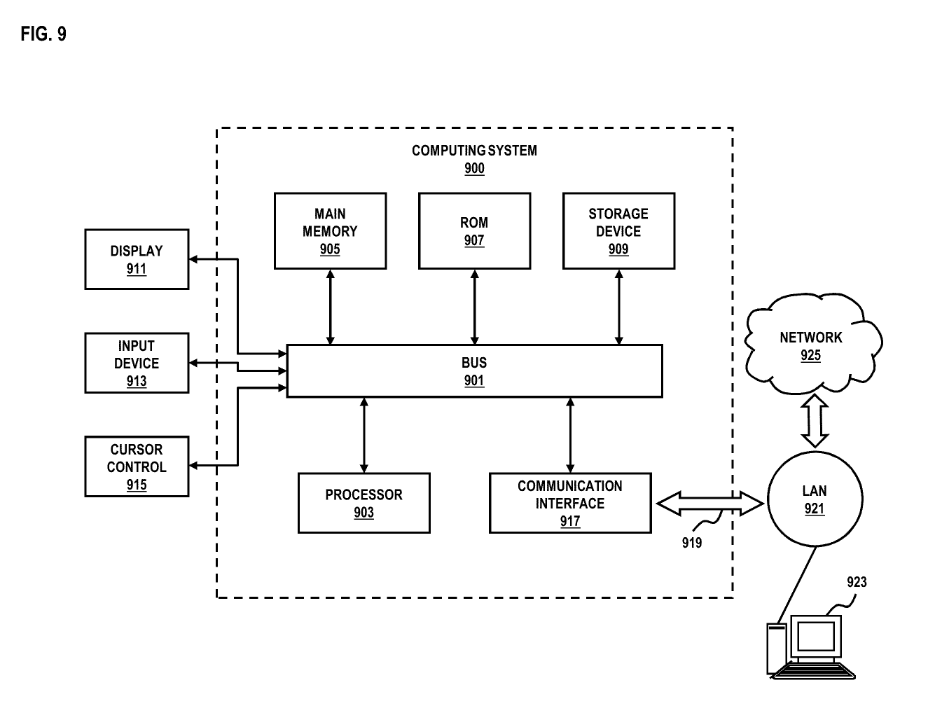

FIG. 9 illustrates computing hardware (e.g., computer system) 900 upon which exemplary embodiments can be implemented. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an exemplary embodiment, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement exemplary embodiments. Thus, exemplary embodiments are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an exemplary embodiment through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

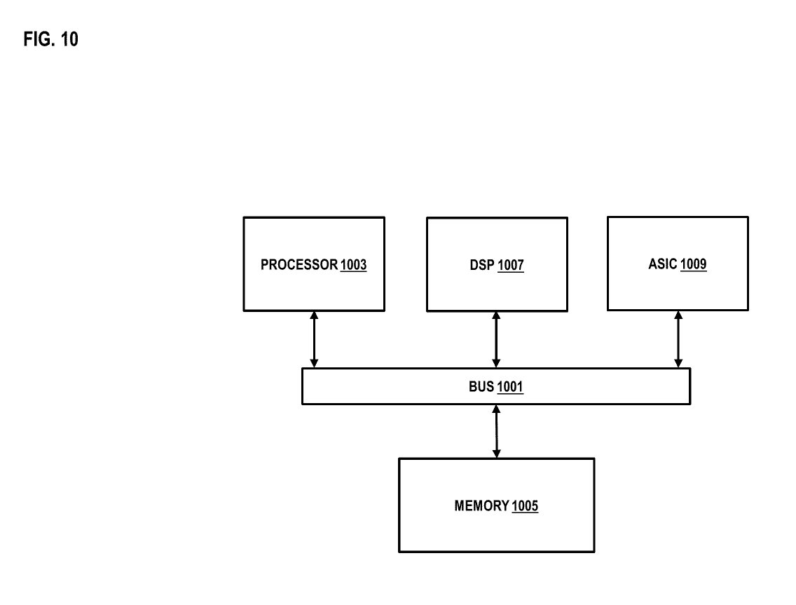

FIG. 10 illustrates a chip set 1000 upon which an embodiment of the invention may be implemented. Chip set 1000 is programmed to present a slideshow as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of FIGS. 2 and 3, as well as a means for presenting the graphical user interface of FIGS. 5-8.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to providing notification of a change in path condition. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
initiating communication with a user for creation of a trouble ticket by an online trouble ticket service;
determining whether the user is associated with an online account of the trouble ticket service; and
presenting, based on the determination, a graphical user interface that includes a feedback area to specify information indicating a reason for non-usage of the online account for the trouble ticket service.

2. A method according to claim 1, wherein the information indicating the reason includes textual data specifying either,
the user did not know existence of the online account,
the user has forgotten credential information for the online account,
the user is waiting for repair activity,
the user states an online system providing the online trouble ticket service is complex or slow,
the online trouble ticket service is unavailable, or
a combination thereof.

3. A method according to claim 1, further comprising:
presenting an answer button to submit the information specifying the reason.

4. A method according to claim 3, further comprising:
generating the trouble ticket in response to the submission of the reason.

5. A method according to claim 1, further comprising:
receiving a request from a user device associated with the user for the creation of the trouble ticket.

6. A method according to claim 1, wherein the request is generated via an application that includes an email application, browser application, or a voice portal.

7. A method according to claim 1, further comprising:
prompting the user to create a new online account based on the determination that the user is not associated with an online account.

8. An apparatus comprising:
at least one processor; and
at least one memory including computer program code for one or more programs,
the at least one memory and the computer program code configured to, with the at least one processor, cause the apparatus to perform at least the following,
initiate communication with a user for creation of a trouble ticket by an online trouble ticket service,
determine whether the user is associated with an online account of the trouble ticket service, and
present, based on the determination, a graphical user interface that includes a feedback area to specify information indicating a reason for non-usage of the online account for the trouble ticket service.

9. An apparatus according to claim 8, wherein the information indicating the reason includes textual data specifying either,
the user did not know existence of the online account,
the user has forgotten credential information for the online account,
the user is waiting for repair activity,
the user states an online system providing the online trouble ticket service is complex or slow,
the online trouble ticket service is unavailable, or
a combination thereof.

10. An apparatus according to claim 8, wherein the apparatus is further caused to:
present an answer button to submit the information specifying the reason.

11. An apparatus according to claim 10, wherein the apparatus is further caused to:
generate the trouble ticket in response to the submission of the reason.

12. An apparatus according to claim 8, wherein the apparatus is further caused to:
receive a request from a user device associated with the user for the creation of the trouble ticket.

13. An apparatus according to claim 8, wherein the request is generated via an application that includes an email application, browser application, or a voice portal.

14. An apparatus according to claim 8, wherein the apparatus is further caused to:
prompt the user to create a new online account based on the determination that the user is not associated with an online account.

15. A system comprising:
an online trouble ticket system configured to initiate communication with a user for creation of a trouble ticket and to determine whether the user is associated with an online account of the trouble ticket system,
wherein the trouble ticket system is further configured to present, based on the determination, a graphical user interface that includes a feedback area to specify information indicating a reason for non-usage of the online account for the trouble ticket service.

16. A system according to claim 15, wherein the information indicating the reason includes textual data specifying either,
the user did not know existence of the online account,
the user has forgotten credential information for the online account,
the user is waiting for repair activity,
the user states an online system providing the online trouble ticket service is complex or slow,
the online trouble ticket service is unavailable, or
a combination thereof.

17. A system according to claim 15, wherein the trouble ticket system is further configured to present an answer button to submit the information specifying the reason.

18. A system according to claim 17, wherein the trouble ticket system is further configured to generate the trouble ticket in response to the submission of the reason.

19. A system according to claim 15, wherein the trouble ticket system is further configured to receive a request from a user device associated with the user for the creation of the trouble ticket.

20. A system according to claim 15, wherein the request is generated via an application that includes an email application, browser application, or a voice portal.

21. A system according to claim 15, wherein the trouble ticket system is further configured to prompt the user to create a new online account based on the determination that the user is not associated with an online account.
